(19) United States
(12) Patent Application Publication
(10) Pub. No.: US 2025/0272623 A1
(43) Pub. Date: Aug. 28, 2025

(54) System and method to determine out of balance conditions

(71) Applicant: Bank of America Corporation, Charlotte, NC (US)

(72) Inventors: Rajalakshmi Arumugam, Chennai (IN); Anil Garg, Gurugram (IN); Vishal Bansal, Ghaziabad (IN); Kapil Jain, Gurgaon (IN); Shailendra Kumar, Gorakhpur (IN); Arif Ahmad Khan, New Delhi (IN); Mallapragada Nagaharini, Gannavaram (IN); Eshan Sama, Noida (IN)

(21) Appl. No.: 18/586,223

(22) Filed: Feb. 23, 2024

(51) Int. Cl. G06Q 10/0631

(52) U.S. Cl. CPC G06Q 10/0631

(57) ABSTRACT

An out-of-balance (OOB) ticket is generated when an OOB condition occurs in relation to a product, and product information related to the OOB ticket is accessed. The product information comprises a plurality of features associated with the product associated with the OOB ticket. A subset of features from the product information is extracted to determine relationships between cause agents and the product associated with the OOB ticket. A probability value is determined for each scenario type, wherein each probability value indicates a likelihood that a corresponding scenario type caused the OOB condition associated with the product. A scenario type associated with a highest probability value is output. Remedial actions to remedy the OOB condition are generated for one or more scenario types based on user defined rules. The remedial actions are performed based on a primary cause identified in the scenario type.

### TECHNICAL FIELD

The present disclosure relates generally to maintaining consistency of data logs, and more specifically to a system and method to determine out of balance conditions between two or more data logs.

### BACKGROUND

An out-of-balance (OOB) condition occurs when there is a mismatch between the actual data items contained in a data log and the data items expected in the data log. Out-of-balance (OOB) conditions in data logs need to be resolved on a timely basis in order to maintain integrity and correctness of the data items exchanged between data logs and thereby the data logs themselves. When an OOB condition occurs, it needs to be investigated to identify errors that caused the OOB condition. The investigations are currently performed manually, require personnel having an in-depth understanding of the operations of entities exchanging data, and require working with relatively large amount of data items. As a result, the process is time consuming and prone to errors.

### SUMMARY

Embodiments of the disclosure are directed to determining the cause of an out-of-balance (OOB) condition and identifying actions to be taken to remedy the OOB condition. When an OOB ticket is received, multiple cause agents are extracted from a library of cause agents and from historical data of previously investigated OOB tickets. This list of cause agents is used to generate scenarios, each of which includes one or more cause agents that resulted in the OOB condition. Multiple scenario types are then generated, with each scenario type having a unique identifier, name of the entity associated with the OOB condition, and a primary cause that resulted in the OOB condition. The primary cause in each scenario type is based on multiple cause agents.

In addition to generating the different scenario types, attributes related to the OOB ticket are also obtained. However, the number of attributes can be very large, and not all attributes pertain to every OOB condition, and therefore may not be required in the analysis. As a result, in one embodiment, only attributes specific to a given OOB may be selected. Once the attributes specific to the OOB condition are selected, relationships between the one or more cause agents and a product associated with the OOB ticket are determined. Determining the relationships includes determining linear correlations between the one or more cause agents and the product, determining chronological relationships between the one or more cause agents and the product, and generating heuristics of relationships between the two or more of the cause agents. In determining the linear correlations, it is determined whether there exists strong or weak correlations between the cause agents and the products. These relationships are then used to determine the most probable scenario type of an OOB and its probability value. In addition, the process will also generate one or more new scenario types different from the previously generated scenario types. The one or more new scenario types are generated based on new cause agents that are different from the one or more cause agents in the OOB ticket. For each scenario type, different remedial actions are created using user defined rules. These remedial actions are provided to the appropriate teams (users) depending on the primary cause in the scenario type for fixing the OOB condition.

Certain embodiments of this disclosure provide unique solutions to technical problems encountered in determining the causes of an OOB condition by using current and historic data items related to a given OOB to generate different scenarios that could have resulted in the OOB condition. Each scenario is a combination of one or more cause agents that create the OOB condition. Also, multiple scenario types are created, each of which includes an entity related to the OOB condition and a primary cause of the OOB condition. The solution also utilizes attributes specific to an OOB condition and determining the relationships between the one or more cause agents and an entity associated with the OOB condition. These relationships are then used to determine the most probable scenario type and probability value of the scenario type.

In certain embodiments, this disclosure may particularly be integrated into a practical application of a computer system for determining the causes of an OOB condition, which determines different scenario types including the different cause agents and determines the most probable scenario type of the given OOB condition. Once the most probable scenario type is determined, remedial actions to remedy the OOB condition are performed based on the primary cause for the OOB condition as indicated in the scenario type. Therefore, by providing a more specific cause and the corresponding remedial actions to be performed, the process is faster, less prone to errors, and more efficient. This may improve the underlying computing system in several ways. First, it may increase the throughput and efficiency of the processors that are used to handle the data logs. Second, it may reduce bottlenecks in the network that are caused by communicating data associated with the OOB conditions. Third, it may promote the efficient use of memory that is otherwise wasted managing data associated with OOB conditions.

In one embodiment, a system includes a memory that stores a plurality of scenario types, wherein each scenario type comprises at least one or more cause agents, wherein each cause agent indicates an action that caused one or more out-of-balance conditions. The system also includes a processor operably coupled to the memory and configured to receive an out-of-balance (OOB) ticket that is generated when an out-of-balance condition occurs in relation to a product and access product information related to the OOB ticket. The product information comprises a plurality of features associated with the product associated with the OOB ticket. The processor is further configured to extract a subset of features from the product information, and determine relationships between the one or more cause agents and the product associated with the OOB ticket. The relationships are determined based at least in part upon the subset of features extracted from the product information. The processor is further configured to apply the determined relationships to the plurality of scenario types stored in the memory to determine a probability value for each of the plurality of scenario types, determine a scenario type associated with a highest probability value, and output the determined scenario type with the highest probability value. Each probability value indicates a likelihood that a corresponding scenario type caused the out-of-balance (OOB) condition associated with the product.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with one or more embodiments of the present disclosure; and

FIG. 2 illustrates a flowchart of an example method for determining an out-of-balance condition, in accordance with one or more embodiments of the present disclosure.

### DETAILED DESCRIPTION

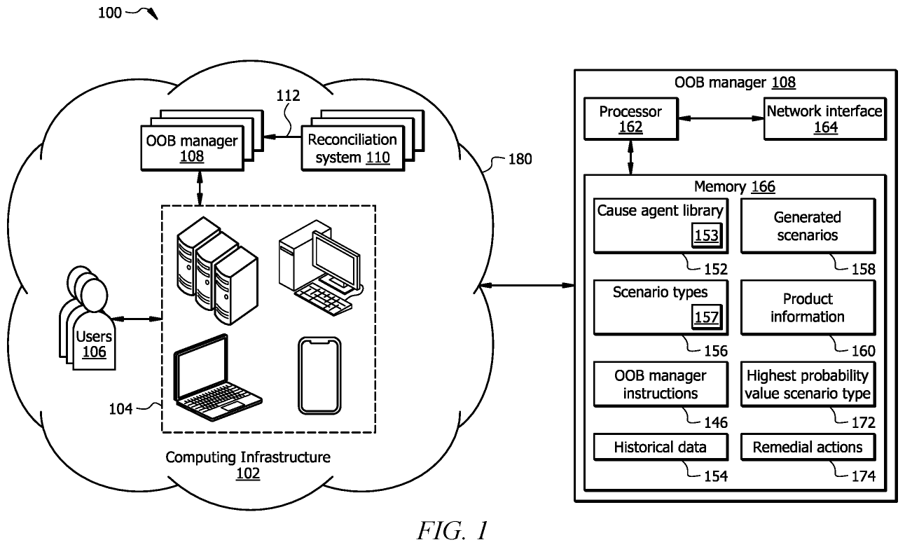

FIG. 1 is a schematic diagram of a system 100 that includes a computing infrastructure 102 connected to a network 180 and out-of-balance (OOB) manager 108. Embodiments of the disclosure are directed to determining the cause of an out-of-balance (OOB) condition and identifying actions to be taken to remedy the OOB condition. When an OOB ticket 112 is received, multiple cause agents are extracted from a library of cause agents and from historical data of previously investigated OOB tickets. This list of cause agents is used to generated scenarios, each of which includes one or more cause agents that resulted in the OOB condition. Multiple scenario types are then generated, with each scenario type having a unique identifier, name of the entity associated with the OOB condition and a primary cause that resulted in the OOB condition. The primary cause in each scenario type is based on multiple cause agents. In addition to generating the different scenario types, multiple attributes related to the OOB ticket are also obtained. Attributes specific to a given OOB are selected from the multiple attributes. Once the attributes specific to the OOB condition are selected, relationships between the one or more cause agents and a product associated with the OOB ticket are determined. The relationships are then used to determine the most probable scenario type of an OOB and its probability value. In addition, the process will also generate one or more new scenario types different from the previously generated scenario types. For each scenario type, different remedial actions are created using user defined rules. These remedial actions are provided to the appropriate teams (users) depending on the primary cause in the scenario type for fixing the OOB condition.

Computing infrastructure 102 may include a plurality of hardware and software components. The hardware components may include, but are not limited to, computing devices 104 such as desktop computers, tablet computers, laptop computers, servers and data centers, mainframe computers, and other hardware devices such as printers, routers, hubs, switches, and memory all connected to the network 180. Software components may include software applications that are run by one or more of the computing devices 104 including, but not limited to, operating systems, user interface applications, third party software, database management software, service management software, mainframe software, metaverse software and other customized software programs implementing particular functionalities. For example, software code relating to one or more software applications may be stored in a memory device and one or more processors (e.g., belonging to one or more computing devices 104) may execute the software code to implement respective functionalities (e.g., an out-of-balance manager 108). In one embodiment, at least a portion of the computing infrastructure 102 may be representative of an Information Technology (IT) infrastructure of an organization.

One or more of the computing devices 104 may be operated by a user 106 to perform data interactions within the computing infrastructure 102.

One or more computing devices 104 of the computing infrastructure 102 may be representative of a computing system which hosts software applications that may be installed and run locally or may be used to access software applications running on a server. The computing system may include mobile computing systems including smart phones, tablet computers, laptop computers, or any other mobile computing devices or systems capable of running software applications and communicating with other devices. The computing system may also include non-mobile computing devices such as desktop computers or other non-mobile computing devices capable of running software applications and communicating with other devices. In certain embodiments, one or more of the computing devices 104 may be representative of a server running one or more software applications to implement respective functionality (e.g., out-of-balance manager 108) as described below. In certain embodiments, one or more of the computing devices 104 may run a thin client software application where the processing is directed by the thin client but largely performed by a central entity such as a server.

The network 180, in general, may be a wide area network (WAN), a personal area network (PAN), a cellular network, or any other technology that allows devices to communicate electronically with other devices. In one or more embodiments, network 180 may be the Internet.

At least a portion of the computing infrastructure 102 (e.g., one or more computing devices 104) may implement an out-of-balance manager 108 which may perform a plurality of operations associated with determining the cause of an out-of-balance (OOB) condition and identifying actions to be taken to remedy the OOB condition. The out-of-balance manager 108 comprises a processor 162, a memory 166, and a network interface 164. The out-of-balance manager 108 may be configured as shown in FIG. 1 or in any other suitable configuration. The processor 162 comprises one or more processors operably coupled to the memory 166. The processor 162 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 162 may be a programmable logic device, a microcontroller, a microprocessor, or any suitable combination of the preceding. The processor 162 is communicatively coupled to and in signal communication with the memory 166. The one or more processors are configured to process data and may be implemented in hardware or software. For example, the processor 162 may be 8-bit, 16-bit, 32-bit, 64-bit or of any other suitable architecture. The processor 162 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

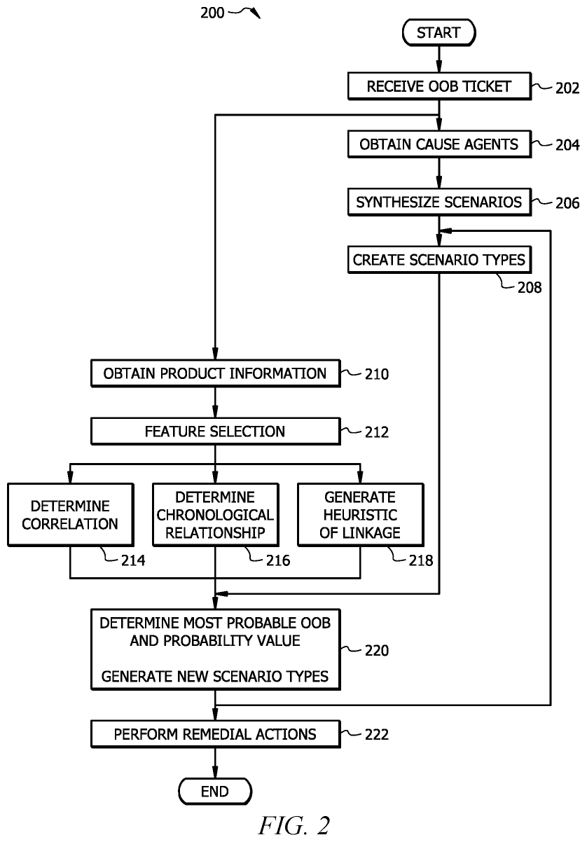

The one or more processors 162 are configured to execute instructions (e.g., out-of-balance manager instructions 146) to implement the out-of-balance manager 108 when the out-of-balance manager 108 receives an out-of-balance ticket 112. The out-of-balance ticket 112 may be received from one or more reconciliation systems 110 that check for data integrity of one or more data logs at user-defined time intervals (every 24 hours, biweekly, monthly, etc.). The reconciliation systems 110 may generate an out-of-balance ticket 112 upon detection of an out-of-balance (OOB) condition, which occurs when there is a mismatch between the data items contained in a data log and the data items expected to be in the data log. In this way, processor 162 may be a special-purpose computer designed to implement the functions disclosed herein. The out-of-balance manager 108 is configured to operate as described with reference to FIG. 2. For example, the processor 162 may be configured to perform at least a portion of the method 200 as described in FIG. 2.

The memory 166 comprises a non-transitory computer-readable medium such as one or more disks, tape drives, or solid-state drives, and may be used as an over-flow data storage device, to store programs when such programs are selected for execution, and to store instructions and data that are read during program execution. The memory 166 may be volatile or non-volatile and may comprise a read-only memory (ROM), random-access memory (RAM), ternary content-addressable memory (TCAM), dynamic random-access memory (DRAM), and static random-access memory (SRAM).

The memory 166 is operable to store scenario types 156, cause agent library 152, historical data 154, product information 162, generated scenarios 158, highest probability value scenario type 172, remedial actions 174, and the out-of-balance manager instructions 146. The out-of-balance manager instructions 146 may include any suitable set of instructions, logic, rules, or code operable to execute on the out-of-balance manager 108.

The network interface 164 is configured to enable wired and/or wireless communications with other elements of system 100. The network interface 164 is configured to communicate data between the OOB manager 108 and other devices, systems, or domains (e.g., computing devices 104). For example, the network interface 164 may comprise a Wi-Fi interface, a LAN interface, a WAN interface, a modem, a switch, or a router. The processor 162 is configured to send and receive data using the network interface 164. The network interface 164 may be configured to use any suitable type of communication protocol as would be appreciated by one of ordinary skill in the art.

The out-of-balance manager 108 is configured to receive an out-of-balance (OOB) ticket 112, determine the out-of-balance condition that caused the generation of the OOB ticket 112 and provide one or more remedial actions to remedy the OOB condition. The OOB manager 108 may be configured to monitor for incoming OOB tickets 112 and perform the tasks discussed herein in response to receiving the OOB ticket 112. Upon receipt of an OOB ticket 112, the OOB manager 108 may be configured to obtain one or more cause agents 153 from a cause agent library 152 and from historical data 154 of previously investigated OOB tickets 112. In some embodiments, the OOB manager 108 may implement natural language processing techniques to obtain information contained in the OOB ticket 112 and use the information to obtain a list of cause agents 153 from the cause agent library 152. As used herein, cause agents (and variations thereof) may refer to incidents or events that caused the OOB condition to occur and thereby the corresponding OOB ticket to be generated. An OOB condition that is indicated by an OOB ticket 112 may be caused by a variety of factors, both internal and external to the organization. For example, external factors may be market events or settlement issues in stock exchanges. In another example, internal factors may include corporate action or system failures in the organization. Thus, there is not necessarily one single cause that creates an OOB condition. The OOB manager 108, therefore, refers to historical data to obtain many possible cause agents that previously caused the OOB condition.

Using the obtained cause agents, the OOB manager 108 may generate (or synthesize) different scenarios 158 including the cause agents. As used herein, a scenario 158 may include a combination of cause agents which have led to the OOB condition. In addition, using the historical data, the OOB manager 108 determines a probability of a cause of an OOB condition using the historical data. The OOB manager 108 may use the historical data to determine cause agents of previous OOB conditions and based on the findings determine a probability that a cause of a current OOB condition is/are particular cause agent(s). In some embodiments, the OOB manager 108 may utilize a Retrieval-Augmented Generation (RAG) and Statistical model to generate the different scenarios 158. The Retrieval-Augmented Generation (RAG) and Statistical model is trained on the input from a reference library 152 of cause agents 153 and historical data 154 from global reconciliation systems to generate a multitude of scenarios which are a combination of one or more OOB cause agents which leads to the OOB condition.

The OOB manager 108 may be further configured to create various scenario types 156 using the generated scenarios 158. Each scenario type 156 has a unique identifier and includes one or more contextual attributes (e.g., name of company, organization, department, team, group) pertaining to the generated OOB condition, a primary cause of the OOB condition, and one or more cause agents for the primary cause. For instance, a scenario type 156 may identify the primary cause as ‘corporate action’ and list the cause agents as A2, A3, A4, A5, A6. This would mean that the cause agents A2, A3, A4, A5, A6 triggered a certain type of corporate action due to which an OOB condition has occurred. As discussed above, this scenario type has been predicted based on historical data and statistical data. The OOB manager 108 may similarly identify all potential scenario types 156 for an OOB condition.

The scenario types 156 represent a relatively limited data set and may not be adequate for investigating an OOB condition. In some embodiments, features or attributes relating to the product in the OOB ticket 112 and the OOB condition are beneficial for a more robust investigation. It may thus be beneficial to backtrack to obtain data that was received into the reconciliation system prior to the generation of the OOB ticket 112. In an embodiment, backtracking may include going back in time prior to the generation of the OOB ticket 112 to gather the data up to the time of generation of the OOB ticket 112. The backtracking may be for a user-defined time period that may include hours, days, weeks, months prior to the generation of the OOB ticket.

When an OOB ticket 112 has been generated when an OOB condition occurs in relation to a product, the OOB manager 108 is provided product information 160 that also includes the data obtained by backtracking, as discussed above. As mentioned above, the product information 160 includes a plurality of features (attributes) associated with the product in the OOB ticket 112 and that could help with the investigation of the OOB condition. However, not all features related to a product are necessarily relevant for investigating the OOB condition. Certain features are specific for a given OOB condition, while the same features may not be relevant for other OOB conditions. In order to reduce the data set and thereby make the process more efficient, the OOB manager 108 extracts a subset of the features to aid in creation of relatively smaller data sets which are relevant to the OOB condition. For instance, in a banking use case, if the OOB ticket 112 pertains to cash products, then features related to securities may be omitted to reduce the data set. In an embodiment, the OOB manager 108 utilizes a recursive feature elimination (RFE) algorithm to extract the subset of features to aid in creation of relatively smaller training data sets which are relevant to the OOB condition.

Once the attributes specific to the OOB condition are selected, the OOB manager 108 may determine relationships between the one or more cause agents and a product associated with the OOB ticket 112. In an embodiment, one relationship may include linear correlations between the one or more cause agents and the product. Linear correlations indicate whether there exists a strong or a weak correlation between the cause agents and the products. In this case, a certain product may have one or more cause agents that are more closely related (more relevant) to the product than other cause agents. For instance, in a banking use case, if the product is cash, then the product will not have an ‘International Securities Identification Number (ISIN) change’ as a cause agent, since this cause agent is applicable to products including securities. Therefore, there exists a stronger correlation between cause agent ‘ISIN change’ and products including securities, and a weaker correlation between cause agent ‘ISIN change’ and products including cash.

In another embodiment, a relationship may include a chronological relationship between the one or more cause agents and the product. In this case, cause agents pertaining to a time factor may be more relevant to a certain products than other products. For instance, in a banking use case, cause agents related to end of day trade settlements in a stock exchange are more relevant to products like securities as opposed to cash.

In yet another embodiment, a relationship may be generated using heuristics of linkages between the two or more of the cause agents. In this case, the relationship may indicate dependency between two or more cause agents. For example, in a banking use case, a relationship may indicate that if a cause agent ‘expiry of security’ occurs, then cause agent ‘delist security’ may also occur, since per organizational procedures if a security has expired or no longer offered, then the security may be delisted from an exchange.

The OOB manager 108 is configured to use the relationships to determine the most probable scenario type and its probability value. In addition, the OOB manager 108 is configured to generate one or more new scenario types different from the previously generated scenario types. The one or more new scenario types are generated based on new cause agents that are different from the one or more cause agents in the OOB ticket 112. In one embodiment, the OOB manager 108 uses dynamically adjustable differential equations to generate scenario types that have not been previously determined. These new scenario types are added to the scenario types 156 already created, as discussed above. The OOB manager 108 identifies the probability of any particular scenario type being the most likely scenario for a particular OOB ticket 112. In an embodiment, the OOB manager 108 may apply the relationships, as determined above, to the scenario types 156 to determine a probability value 157 for each scenario type 156. The OOB manager 108 may then output the scenario type having highest probability value 172 of an OOB condition. In an embodiment, each probability value 157 indicates a likelihood that a corresponding scenario type 156 caused the out-of-balance (OOB) condition associated with the product. In one embodiment, the OOB manager 108 utilizes reservoir computing techniques (e.g., next generation reservoir computing techniques) to determine the most probable scenario type and its probability value, and to generate one or more new scenario types different from the previously generated scenario types.

The OOB manager 108 is configured to generate one or more remedial actions 174 for each scenario type 156 based on user defined rules. The one or more remedial actions 174 are to remedy the OOB condition. As discussed above, each scenario type 156 identifies a primary cause of the OOB condition, and the OOB manager 108 may be configured to provide the one or more remedial actions 174 to concerned departments within the entity (organization) for performing the remedial actions based upon the primary cause. For instance, if the primary cause in the scenario type determined to be the most probable is ‘corporate action’, then the remedial steps 174 are provided to the concerned departments within the entity (e.g., management) to handle the OOB condition.

It may be noted that in an example banking use case, an entity may include a bank or different departments within the bank, products may include cash, securities, and the like, a data log may include books of accounts that include financial transactions.

FIG. 2 illustrates a flowchart of an example method 200 for determining an out-of-balance condition, in accordance with one or more embodiments of the present disclosure. The method 200 may be performed by the OOB manager 108 shown in FIG. 1.

At operation 202, the OOB manager 108 receives an OOB ticket 112.

At operation 204, the OOB manager 108 obtains one or more cause agents from a library of cause agents 152 and from historical data 154 of previously investigated OOB tickets.

At operation 206, the OOB manager 108 generates different scenarios 158 including the cause agents 152. As described above, each scenario 158 includes a combination of cause agents which have led to the OOB condition. In addition, using the historical data, the OOB manager 108 determines a probability of a cause of an OOB condition using the historical data. The OOB manager 108 may use the historical data to determine cause agents of previous OOB conditions and based on the findings determine a probability that a cause of a current OOB condition is/are particular cause agent(s).

At operation 208, the OOB manager 108 creates various scenario types 156 using the generated scenarios 158. Each scenario type 156 has a unique identifier and includes the name of the organization (or entity) pertaining to the generated OOB condition, a primary cause of the OOB condition, and one or more cause agents for the primary cause.

At operation 210, the OOB manager 108 receives product information 160 including the data sets related to the OOB ticket 112. As mentioned above, the product information includes a plurality of features (attributes) associated with the product in the OOB ticket and that could help with the investigation of the OOB condition.

At operation 212, the OOB manager 108 extracts a subset of the features to aid in creation of relatively smaller data sets which are relevant to the OOB condition being worked on. As discussed, although a plurality of features (attributes) associated with the product in the OOB ticket are obtained, not all features related to a product are relevant for investigating the OOB condition. Certain features are specific for a given OOB condition, while the same features may not be relevant for other OOB conditions. In order to reduce the data set and thereby make the process more efficient, the OOB manager 108 extracts a subset of the features to aid in creation of relatively smaller data sets which are relevant to the OOB condition.

The OOB manager 108 may determine relationships between the one or more cause agents and a product associated with the OOB ticket. Thus, at operation 214, the OOB manager 108 determines linear correlations between the one or more cause agents and the product. Linear correlations indicate whether there exists a strong or a weak correlation between the cause agents and the products. At operation 216, the OOB manager 108 determines chronological relationships between the one or more cause agents and the product. The chronological relationships may be determined based on the understanding that cause agents pertaining to a time factor may be more relevant to a certain products than other products. At operation 218, the OOB manager 108 generates a relationship using heuristics of linkages between the two or more of the cause agents. In this case, the relationship based on heuristics may indicate dependency between two or more cause agents.

At operation 220, the OOB manager 108 uses the relationships to determine the most probable scenario type and its probability value. In addition, the OOB manager 108 generates one or more new scenario types different from the previously generated scenario types. The one or more new scenario types are generated based on new cause agents that are different from the one or more cause agents in the OOB ticket 112. In determining the probability values, the OOB manager 108 also considers the scenario types determined in operation 208. Additionally, new scenario types generated are added to the scenario types determined in operation 208.

At operation 222, the OOB manager 108 generates one or more remedial actions 174 for each scenario type 156 based on user defined rules. The one or more remedial actions 174 are to remedy the OOB condition. As discussed above, each scenario type 156 identifies a primary cause of the OOB condition, and the OOB manager 108 may be configured to provide the one or more remedial actions 174 to concerned departments within the entity (organization) for performing the remedial actions based upon the primary cause.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
a memory that stores a plurality of scenario types, wherein each scenario type comprises at least one or more cause agents, wherein each cause agent indicates an action that caused one or more out-of-balance conditions; and
a processor operably coupled to the memory and configured to:
receive an out-of-balance (OOB) ticket that is generated when an out-of-balance condition occurs in relation to a product;
access product information related to the OOB ticket, wherein the product information comprises a plurality of features associated with the product associated with the OOB ticket;
extract a subset of features from the product information;
determine relationships between the one or more cause agents and the product associated with the OOB ticket, wherein the relationships are determined based at least in part upon the subset of features extracted from the product information;
apply the determined relationships to the plurality of scenario types stored in the memory to determine a probability value for each of the plurality of scenario types, wherein each probability value indicates a likelihood that a corresponding scenario type caused the out-of-balance (OOB) condition associated with the product;
determine a scenario type associated with a highest probability value; and
output the determined scenario type with the highest probability value.

2. The system of claim 1, wherein the processor is further configured to determine relationships between the one or more cause agents and the product associated with the OOB ticket by:
determining linear correlations between the one or more cause agents and the product;
determining chronological relationships between the one or more cause agents and the product; and
generating heuristics of relationships between the two or more of the cause agents.

3. The system of claim 1, wherein the processor is further configured to:
extract the one or more cause agents from a cause agent library and from historical data of previously investigated OOB tickets;
generate a plurality of scenarios that caused the received OOB ticket, wherein each scenario includes the one or more cause agents that caused the received OOB ticket; and
generate the plurality of scenario types based at least in part upon the generated plurality of scenarios and the extracted one or more cause agents.

4. The system of claim 1, wherein the processor is further configured to generate one or more new scenario types different from the plurality of scenario types stored in the memory, wherein the one or more new scenario types are generated based on new cause agents that are different from the one or more cause agents in the OOB ticket.

5. The system of claim 1, wherein the processor is further configured to extract the subset of features that are specific to the product associated with the OOB ticket.

6. The system of claim 1, wherein the processor is further configured to generate one or more remedial actions for each scenario type based on user defined rules, and wherein the one or more remedial actions remedy the OOB condition.

7. The system of claim 6, wherein each scenario type identifies a primary cause of the OOB condition, and wherein the identified primary cause is based on multiple cause agents, and the one or more remedial actions are performed based at least in part upon the identified primary cause.

8. A method, comprising:
storing, in a memory, a plurality of scenario types, wherein each scenario type comprises at least one or more cause agents, wherein each cause agent indicates an action that caused one or more out-of-balance conditions;
receiving an out-of-balance (OOB) ticket that is generated when an out-of-balance condition occurs in relation to a product;
accessing product information related to the OOB ticket, wherein the product information comprises a plurality of features associated with the product associated with the OOB ticket;
extracting a subset of features from the product information;
determining relationships between the one or more cause agents and the product associated with the OOB ticket, wherein the relationships are determined based at least in part upon the subset of features extracted from the product information;
applying the determined relationships to the plurality of scenario types stored in the memory to determine a probability value for each of the plurality of scenario types, wherein each probability value indicates a likelihood that a corresponding scenario type caused the out-of-balance (OOB) condition associated with the product;
determining a scenario type associated with a highest probability value; and
outputting the determined scenario type with the highest probability value.

9. The method of claim 8, further comprising:
determining relationships between the one or more cause agents and the product associated with the OOB ticket by:
determining linear correlations between the one or more cause agents and the product;
determining chronological relationships between the one or more cause agents and the product; and
generating heuristics of relationships between the two or more of the cause agents.

10. The method of claim 8, further comprising:
extracting the one or more cause agents from a cause agent library and from historical data of previously investigated OOB tickets;
generating a plurality of scenarios that caused the received OOB ticket, wherein each scenario includes the one or more cause agents that caused the received OOB ticket; and
generating the plurality of scenario types based at least in part upon the generated plurality of scenarios and the extracted one or more cause agents.

11. The method of claim 8, further comprising:
generating one or more new scenario types different from the plurality of scenario types stored in the memory, wherein the one or more new scenario types are generated based on new cause agents that are different from the one or more cause agents in the OOB ticket.

12. The method of claim 8, further comprising:
extracting the subset of features that are specific to the product associated with the OOB ticket.

13. The method of claim 8, further comprising:
generating one or more remedial actions for each scenario type based on user defined rules, wherein the one or more remedial actions remedy the OOB condition.

14. The method of claim 13, wherein each scenario type identifies a primary cause of the OOB condition, and wherein the identified primary cause is based on multiple cause agents, and the one or more remedial actions are performed based at least in part upon the identified primary cause.

15. A non-transitory computer-readable medium storing instructions that when executed by a processor cause the processor to:
store, in a memory, a plurality of scenario types, wherein each scenario type comprises at least one or more cause agents, wherein each cause agent indicates an action that caused one or more out-of-balance conditions;
receive an out-of-balance (OOB) ticket that is generated when an out-of-balance condition occurs in relation to a product;
access product information related to the OOB ticket, wherein the product information comprises a plurality of features associated with the product associated with the OOB ticket;
extract a subset of features from the product information;
determine relationships between the one or more cause agents and the product associated with the OOB ticket, wherein the relationships are determined based at least in part upon the subset of features extracted from the product information;
apply the determined relationships to the plurality of scenario types stored in the memory to determine a probability value for each of the plurality of scenario types, wherein each probability value indicates a likelihood that a corresponding scenario type caused the out-of-balance (OOB) condition associated with the product;
determine a scenario type associated with a highest probability value; and
output the determined scenario type with the highest probability value.

16. The non-transitory computer-readable medium of claim 15, wherein the instructions further cause the processor to:
determine relationships between the one or more cause agents and the product associated with the OOB ticket by:
determining linear correlations between the one or more cause agents and the product;
determining chronological relationships between the one or more cause agents and the product; and
generating heuristics of relationships between the two or more of the cause agents.

17. The non-transitory computer-readable medium of claim 15, wherein the instructions further cause the processor to:
extract the one or more cause agents from a cause agent library and from historical data of previously investigated OOB tickets;
generate a plurality of scenarios that caused the received OOB ticket, wherein each scenario includes the one or more cause agents that caused the received OOB ticket; and
generate the plurality of scenario types based at least in part upon the generated plurality of scenarios and the extracted one or more cause agents.

18. The non-transitory computer-readable medium of claim 15, wherein the instructions further cause the processor to:
generate one or more new scenario types different from the plurality of scenario types stored in the memory, wherein the one or more new scenario types are generated based on new cause agents that are different from the one or more cause agents in the OOB ticket.

19. The non-transitory computer-readable medium of claim 15, wherein the instructions further cause the processor to extract the subset of features that are specific to the product associated with the OOB ticket.

20. The non-transitory computer-readable medium of claim 15, wherein the instructions further cause the processor to:
generate one or more remedial actions for each scenario type based on user defined rules, wherein the one or more remedial actions remedy the OOB condition, wherein each scenario type identifies a primary cause of the OOB condition, and wherein the identified primary cause is based on multiple cause agents, and the one or more remedial actions are performed based at least in part upon the identified primary cause.
